(19) United States
(12) Patent Application Publication
(10) Pub. No.: US 2026/0330904 A1
(43) Pub. Date: Oct. 22, 2026

(54) CLOUD-BASED ENTRY CONTROL DEVICE

(71) Applicant: MDU Netech, Williamsville, NY (US)

(72) Inventors: David STEWART, Williamsville, NY (US); Joseph Thomas Jones STEWART, Williamsville, NY (US); Silfrido Enrique REVEROL PRADA, East Amherst, NY (US)

(21) Appl. No.: 19/468,994

(22) Filed: Feb. 3, 2026

Related U.S. Application Data
(60) Provisional application No. 63/753,434, filed on Feb. 3, 2025.

(51) Int. Cl. G07C 9/00; H04M 1/72424

(52) U.S. Cl. CPC G07C 9/00571; G07C 9/00309; H04M 1/72424; G07C 2009/00642; H04M 2250/52

(57) ABSTRACT

A cloud-based telephone entry unit (TEU). The TEU is designed to be integrated with existing door systems, specifically, electronic door systems, which are energized to maintain a locked configuration of a respective electronic strike plate of the electronic door system. Simply, the TEU allows a first mobile device to send a request to a second mobile device to unlock the electronic door system. A cloud service, or remote server, establishes a communication protocol between the mobile devices, and if the request from the first mobile device is granted by the second mobile device, the remote server then prompts the TEU to deenergize, i.e., unlock, the electronic door system.

### CROSS REFERENCE TO RELATED APPLICATIONS

This application claims priority to U.S. Provisional Application No. 63/753,434, filed Feb. 3, 2025, which application is incorporated by reference herein in its entirety.

### FIELD

The present disclosure generally relates to an entry control device, specifically a cloud-based telephone entry unit (TEU) for an entryway to a building.

### BACKGROUND

Current TEU solutions require an interface to be placed at or near the door. Power, data, phone, and door operator lines (e.g., physical wires) in varying configurations must all be in powered and/or electronical communication with the unit. TEU units are often vandalized or rendered inoperable by residents who are angry they cannot gain entry, are inebriated, or simply have malicious intent toward the property owner. Traditional TEU units are expensive to install, maintain, and are a failure point. A TEU unit is generally configured to interact with a mechanical system (e.g., a magnetic lock system on a door or entryway, a retracting pin in the door system, an electronic door strike system, and other known electronic locking system) based on the credential presented to the particular unit, e.g., RFID key fobs and other known “keys.” The mechanical systems of access control for entryways seldom fail, but traditional TEU units that are operating the mechanical systems are known to be a point of failure.

Failure of a TEU unit is especially dangerous in emergency situations. Traditional TEU units, which are physically connected to a power source, depend on a constant power supply to operate the entryway or door’s locking system. If the power source connected to the TEU unit is lost, then the TEU unit’s functionality is also lost. Additionally, TEU units can present difficulties for first responders. As described above, the need for a credential, such as a key fob, can slow down a response time if an administrative command or credential is not available to the first responders upon arrival. Such consequences include a delayed response time or property damage facilitated by a necessary forced entry at the entryway point.

Therefore, there is a long felt need for an improved TEU unit that can accept a plurality of credentials, such as a key fob, and allows a mobile device to function as a credential for entry of at least one entryway or door. Additionally, there is a security need for a TEU unit that can function during a power loss and is designed to have an emergency protocol to allow entryways to be opened during emergency situations, with or without power.

### SUMMARY

The present disclosure broadly relates to a cloud-based telephone entry unit (“TEU”). The TEU is designed to be integrated with existing door systems, specifically, electronic door systems, which are energized to maintain a locked configuration of a respective electronic strike plate of the electronic door system. Simply, the TEU allows a first mobile device to send a request to a second mobile device to unlock the electronic door system. A cloud service, or remote server, establishes a communication protocol between the mobile devices, and if the request from the first mobile device is granted by the second mobile device, the remote server then prompts the TEU to deenergize, i.e., unlock, the electronic door system, granting access. Preferably, no software or applications are required to be permanently stored locally, on either devices, but optionally, such applications could be downloaded locally to further expedite use.

In some aspects, embodiments of the disclosure provide a telephone entry system, often called an intercom or access control system for buildings such as apartments or gated communities, that replaces traditional buzzing or calling mechanisms with a smartphone-based, cloud-mediated security process. At the core is a centralized telephone entry unit containing a power supply connectable to external power with battery backup for reliability during outages, a relay card with multiple relays to control one or more electric door strikes, a router or modem for internet connectivity, and communication to a remote (cloud) server. An external sign at the entry displays scannable indicia, most commonly a QR code, which a visitor uses with their mobile device (a first mobile device) to initiate access.

In operation, a visitor scans the indicia with their smartphone camera, prompting the invention, via a link or app interaction with the remote server, to display a list of unit numbers without showing resident names to preserve privacy. Selecting a unit sends an authorization request, in real time or substantially so, via the server to the associated resident's mobile device (a second mobile device), without exposing the resident's phone number for enhanced privacy. The resident receives the request and returns a confirmation, which is routed via the server to the entry unit's router. This triggers the relay card to signal and deenergize the one or more electric door strikes, unlocking the door promptly. The system also integrates safety features, such as automatic unlocking during fire panel emergencies, ensuring fail-safe operation.

Variations emphasize practical enhancements: battery backup for power failures, multi-relay support (e.g., 1–32 relays for controlling multiple doors), a housed unit for protection, a privacy-focused list display, anonymous routing via the server, and QR codes that can be geo-tagged and enabling linking to building-specific databases. Overall, the disclosed aspects are configured to provide a secure, contactless, real-time, resident-approved access solution that leverages mobile devices and cloud infrastructure, eliminating traditional, hardware-intensive telephone entry limitations while prioritizing privacy, reliability, and emergency compliance.

An objective of the disclosure is to provide a secure, convenient, and resident-controlled access solution for building entryways, such as apartments, condominiums, or gated communities, via a modern, smartphone-based, cloud-mediated process. This enables visitors to initiate access requests by scanning a displayed QR code or similar identifier, or remotely logging into the application in the absence of an identifier, which triggers real-time authorization routed anonymously via a remote server to the appropriate resident's mobile device (if guest visitor or self-entry), allowing the resident to approve entry remotely without physical presence or exposed phone numbers.

Another objective of the disclosure is to enhance resident privacy and security by displaying only unit numbers or another non-descript identified, without including names on visitor lists, and by mediating communication to prevent unwanted direct contact or data exposure while maintaining control over who enters.

Another objective of the disclosure is to incorporate battery backup for continued operation during power outages, integrated with fire panels to automatically deenergize (unlock) door strikes in emergencies, including multi-door setups.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying drawings, in which:

FIGS. 1 and 2 illustrate high-level schematics of a system the present disclosure;

FIG. 3 illustrates an exemplary embodiment of the physical device of the present disclosure utilized in the system shown in FIGS. 1 and 2;

FIGS. 4A and 4B illustrate a method for controlling access to a building entryway using a cloud-based telephone entry system TEU;

FIGS. 5A-5C illustrate representative flow diagrams for guest authentication and subsequent access requests via either a video/voice call or an SMS-only interaction;

FIGS. 6A-6C illustrate representative flow diagrams for tenant authentication, direct door operation, and the generation of a unique passcode for a guest or contractor;

FIG. 7 illustrates a representative flow diagram for passcode-based access, detailing the validation of an entered passcode against time-based rules to grant or deny entry;

FIG. 8 illustrates a representative flow diagram of the fire emergency protocol, showing the parallel hardware override for immediate door unlocking and the software-based notification process; and,

FIG. 9 illustrates a schematic block diagram of the system's electronic architecture, detailing power distribution, data flow between the router and relay boards, and the fail-safe override signal path from a fire panel.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials, and modifications described and, as such, may, of course, vary. It is also understood that the terminology used herein is for the purpose of describing particular aspects only and is not intended to limit the scope of the claims.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

As used herein, the term “telephone entry unit” or “TEU” is intended to be interpreted broadly and is not limited to traditional systems that rely on telephone landlines or voice-only communication. The term is used for convenience and is intended to encompass a wide range of access control systems, which may also be known in the art as an “intercom system,” “entry control device,” “access control unit,” or similar designations. The defining characteristic of the TEU described in this disclosure is its function of mediating access to a secured entryway by receiving an access request, facilitating remote authorization, and actuating an electronic locking mechanism. Accordingly, the communication pathways described herein, including but not limited to cellular networks, the internet, Wi-Fi, and other data protocols such as MQTT, are all considered to be within the scope of what is meant by a “telephone entry unit” for the purposes of this disclosure.

As described supra, the present disclosure provides a TEU 10 that is designed to control an electric or electronic door strike 19 (hereinafter “e-strike”). One having skill in the art will appreciate that e-strike 19 generally relates to an electromechanical device that replaces the standard strike plate on a door frame M. In a broad sense, e-strike 19 may comprise strike plate 19 (a metal plate that interacts with door latch L of door D), solenoid 33 (an electromagnetic coil that controls the locking mechanism), and latch L or bolt (the component of the door lock that engages with strike plate 19 to secure the door D).

In operation, when access control system 34 (like a keypad, card reader, or intercom) sends an electrical signal to solenoid 33, it activates and deactivates locking mechanism 35, allowing access. solenoid 33 either retracts or releases latch L, depending on whether the system is set to fail-safe or fail-secure. Fail-safe means that strike 19 unlocks when power is lost, ensuring safety in emergencies. Fail-secure means that strike 19 remains locked during a power failure, maintaining security. When solenoid 33 is activated, it moves latch L or bolt B, allowing door D to open.

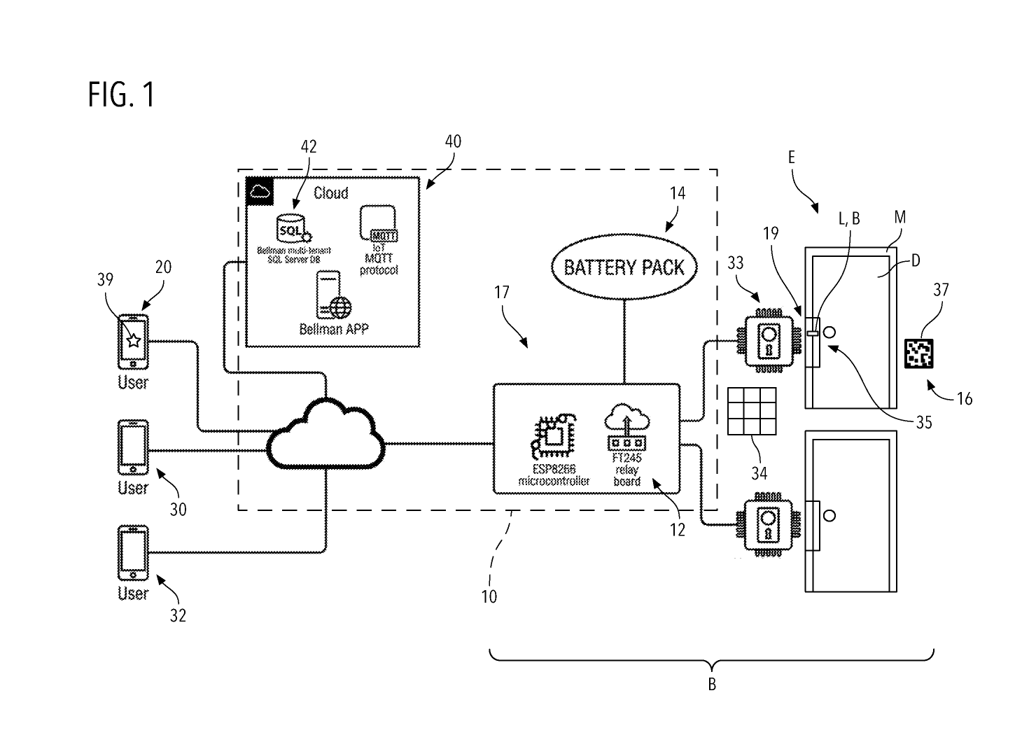

TEU 10 system interfaces with known e-strike 19 systems, providing a simpler and more convenient alternative to traditional TEU 10 systems. As shown in FIG. 1, TEU 10 system may include remote server 40, such as a cloud server, in communication with TEU 10, power supply 11, such battery 14 and/or a building’s own power supply, providing power to box 17, and connection with at least one e-strike 19. Remote server 40, e.g., AWS cloud, etc., hosts an application that is accessed through indicia 16 placed by each of entryways E, e.g., a QR-code 37.

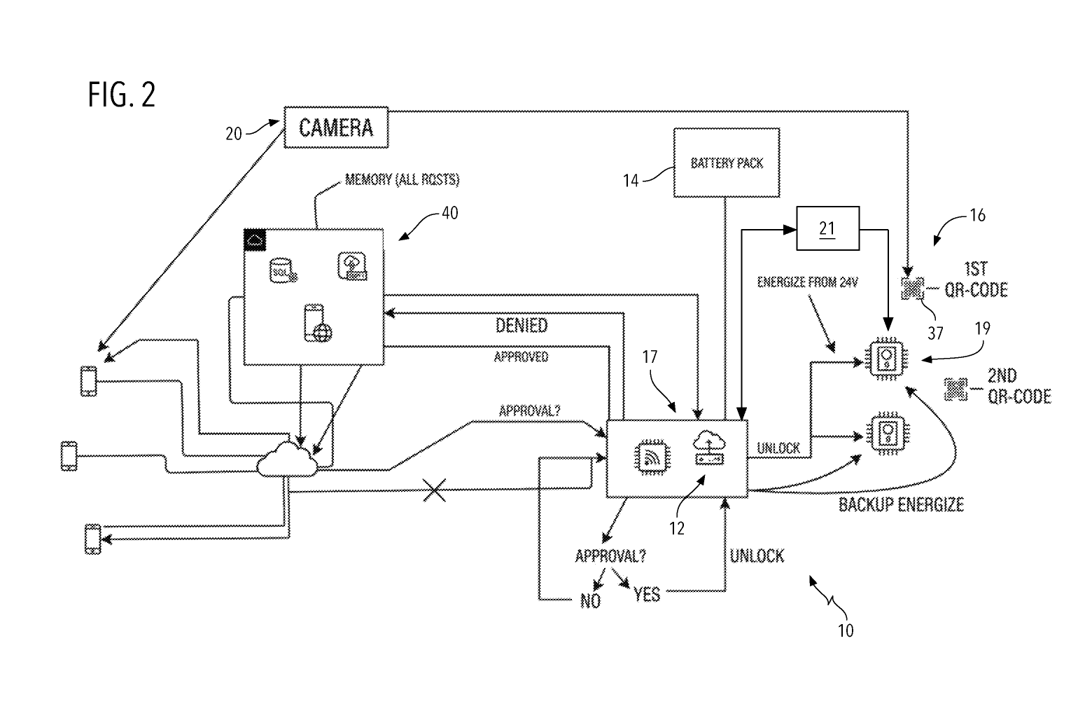

FIG. 2 illustrates a high-level flow diagram of the entry and access protocol of TEU 10 system. In one example of the system:

First, upon arriving at door D connected to TEU 10 system, e.g., a guest or a delivery person, indicia 16 or QR-code 37 is scanned using ubiquitous smartphone camera 20 technology.

Second, QR-code 37 directs the user to interactive database 42 in the remote network or cloud specific for building B and units associated with specific door D.

Third, the guest or delivery person enters the unit number (or other identifier) that they wish to contact to gain entry. In a preferred embodiment, the name of the owner, e.g., the resident, is not displayed for resident safety precautions.

Fourth, the resident’s own cellular device receives a text, call, or video call from remote server 40 stating that a person is at door D and is requesting entry. Camera image 39 can be embedded in the text if the technology is present at building B, i.e., building B has camera 20 system with visibility on particular entryway E and TEU 10 system is in communication with camera 20 system.

Fifth, the resident responds to the text to either enter, deny, report the issues for troubleshooting, or to have the person identify who they are by contacting the resident directly, at which point the QR-scan process is repeated. The resident never has to issue out their number. If “identify” is selected, it is assumed the guest or delivery person has the resident’s contact number on file, further insuring resident safety.

Lastly, upon the resident granting access to the guest, the system triggers a relay (send a signal) within box 17 that allows door’s D locking mechanism 35 to momentarily disengage.

As shown in FIG. 1, relay system 12 within box 17 of Telephone Entry Unit (TEU) 10 system can operate e-strike 19 system of multiple doors and is simply dependent on the capacity of relay card 12 used within box 17 of TEU 10 system. As such, one single TEU 10 system can operate multiple entryways and thus avoids the need for a traditional TEU system installed and connected to each of entryways E of a particular property. Included is indicia 16, e.g., a QR-code 37, associated with each of entryways E and programmed into remote server 40 system and application of TEU 10 system.

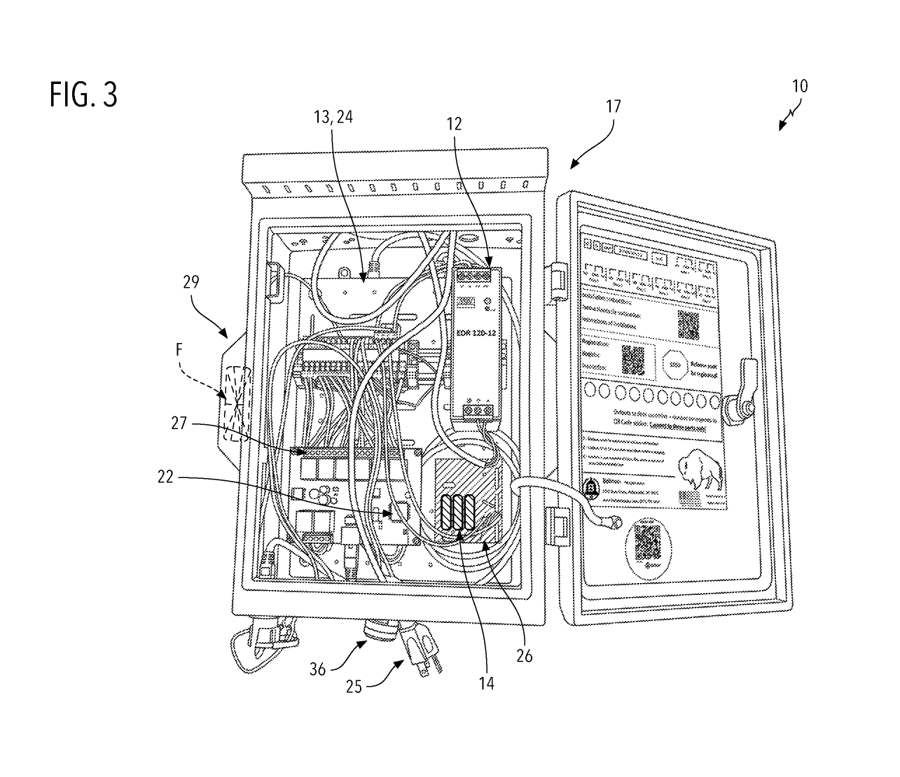

FIG. 3 illustrates an exemplary embodiment of TEU 10 system of the present invention. In one possible configuration, TEU 10 system comprises: housing unit 17 or box; LTE modem 13 with an antenna, e.g., internal antenna 24, or an external antenna; power supply 11 connected to LTE modem 13 which also may be connected to e-strike 19 (or mag lock, or similar analogs or variations); standard wire power connector 25 that is designed to plug into power outlet, e.g., a typical 120 VAC outlet; battery bank 26 having one or more batteries 14 in connection with power supply 11 and/or wire power connector 25 for charging capabilities; an indicator light 36; and relay bank 27 or smart card that preferably has 1-32 (or more) relay cards 12 that is in connection with LTE modem 13 and receives power from power supply 11. In a preferred embodiment, relay bank 27 has microprocessor 22 configured to receive signals from LTE modem 13 and to control each relay of relay bank 27. In some embodiments, housing unit or box 17 may also have air vent 29 to prevent overheating. In other embodiments, air vent 29 could have a fan F that is powered by power supply 11 for active cooling within housing or box 17.

In a preferred embodiment, relay bank 27 or smart card is further arranged to be in communication with a property’s fire panel 21 system and to receive signals from fire panel 21 system (See FIG. 2). TEU 10 system is programmed to receive emergency signals from fire panel 21 system and send a signal to each of connected e-strikes 19 to de-energize and grant entry for first responders. Such emergency protocol is further supported by battery bank 14 in the event of a power failure of building B.

In some embodiments, an additional security layer is provided by incorporating geolocation verification into the access protocol. Upon a guest scanning indicia 16, such as QR-code 37, with their mobile device, the device transmits its current geolocation data to remote server 40 along with the access request. The remote server then compares the received location data against the known geographical coordinates of the specific entryway E associated with the scanned QR-code 37. If the server determines that the user's mobile device is not within a predefined proximity to the entryway E, the access request is automatically denied. This verification step ensures the user is physically present at the door and prevents unauthorized access attempts using a captured image or screenshot of QR-code 37.

The system further provides a method for pre-authorized individuals, such as vendors or expected guests, to gain entry using a unique access code. After performing the initial geo-verified scan of the QR-code 37, the user is presented with an option on their mobile device to enter an access code. This access code, having been previously generated by a resident via the resident's mobile device or by building management, is submitted to remote server 40 for validation. The remote server verifies the code against interactive database 42, confirming its validity for the specific door D and checking for any pre-configured rules. These rules may include one-time use limitations or scheduled access windows, such as allowing entry only on specific days or times. If the code is valid and all conditions are met, remote server 40 instructs TEU 10 to deenergize e-strike 19, granting access.

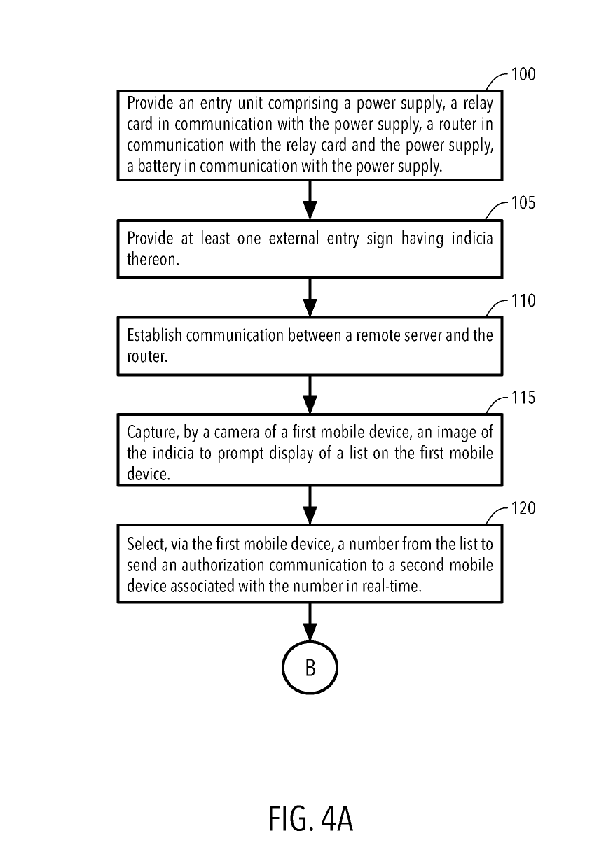

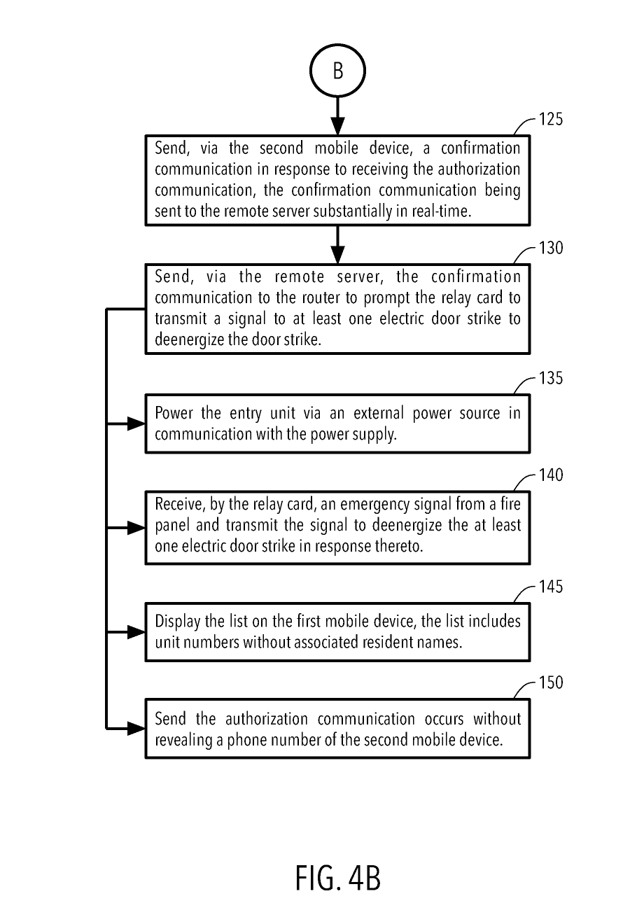

FIGS. 4A and 4B show a method for controlling access to a building entryway E using cloud-based telephone entry system TEU 10. The method includes the step of 100, providing a TEU 10 comprising power supply 11, relay card 12 in communication with power supply 11, router 13 in communication with relay card 12 and power supply 11, and battery 14 in communication with power supply 11. The method further includes the step of 105, providing at least one external entry sign 15 having indicia 16 thereon. The method further includes the step of 110, establishing communication between remote server 40 and router 13. The method further includes the step of 115, capturing, by camera 20 of first mobile device 30, image of indicia 16 to prompt display of list 41 on first mobile device 30. The method further includes the step of 120, selecting, via first mobile device 30, a number from list 41 to send an authorization communication to second mobile device 32 associated with the number substantially in real-time, where substantially generally means that for practical purposes it is in real-time, even if there is some operational delay to propagate signals and actions. The method further includes the step of 125, sending, via second mobile device 32, a confirmation communication in response to receiving the authorization communication, the confirmation communication being sent to remote server 40 substantially in real-time. The method further includes the step of 130, sending, via remote server 40, confirmation communication to router 13 to prompt relay card 12 to transmit a signal to at least one electric door strike 19 to deenergize door strike 19.

In some embodiments, the method may include the step of 135, powering entry unit via external power source 23 in communication with power supply 11. The method may include the step of 140, receiving, by relay card 12, an emergency signal from fire panel 21 and transmitting the signal to deenergize at least one electric door strike 19 in response thereto. The method may include the step of 145, displaying list 41 on first mobile device 30 includes unit numbers without associated resident names. The method may include the step of 150, sending the authorization communication, which occurs without revealing a phone number of second mobile device 32.

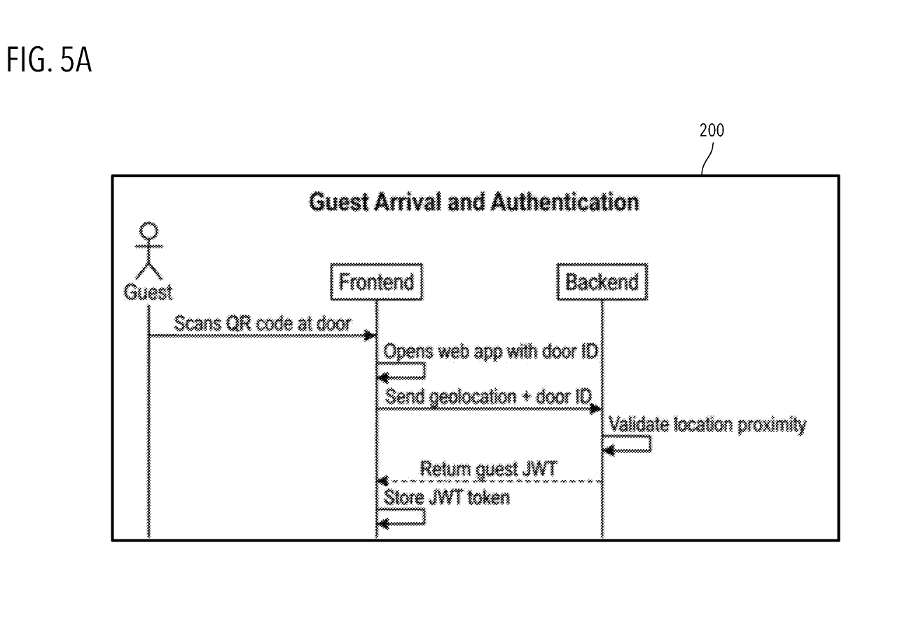

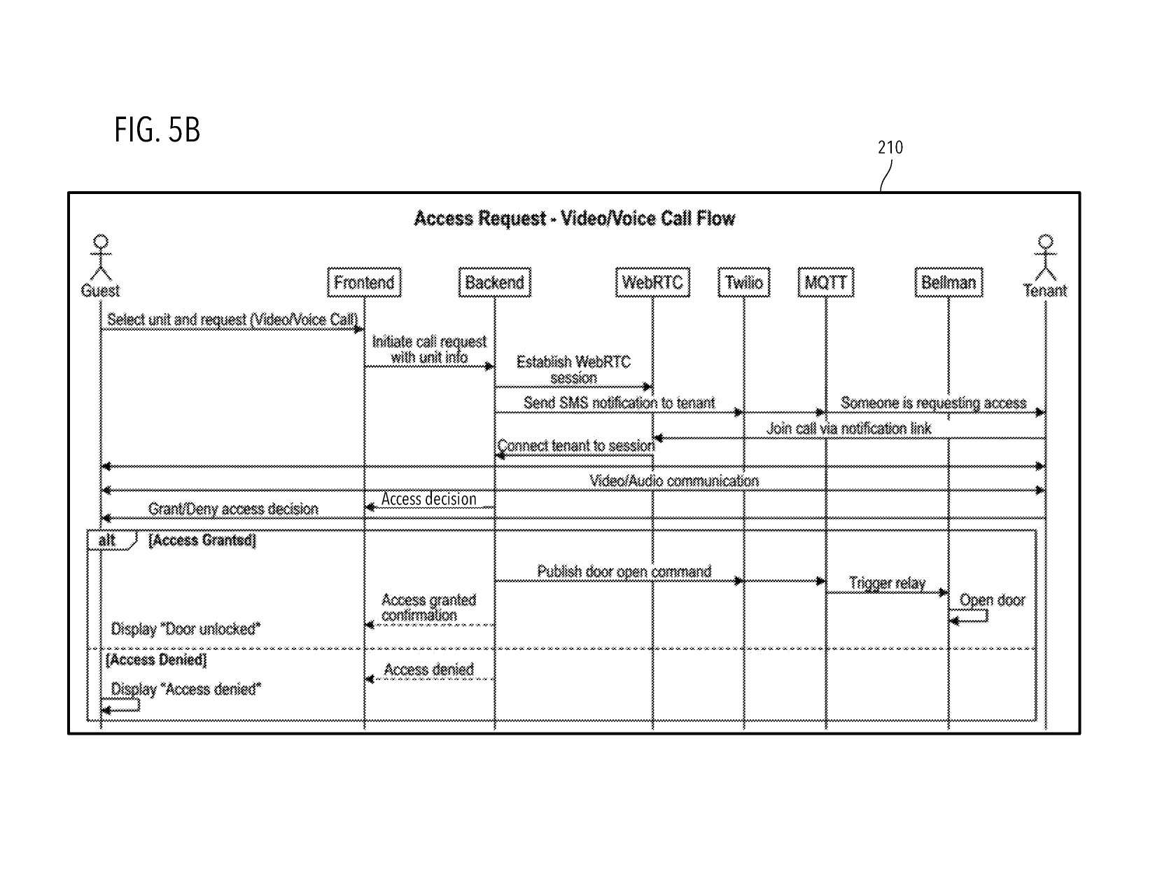

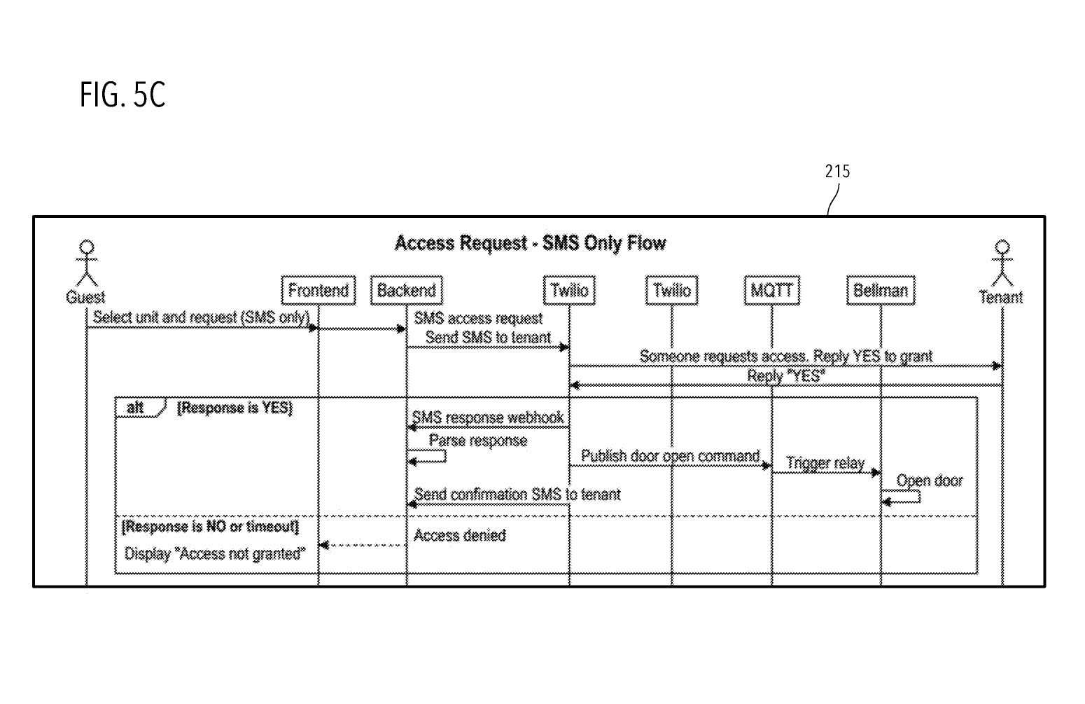

FIG. 5A illustrates a representative flow for guest arrival and initial authentication with the entry control system, 200. The process begins when a guest, using a mobile device, scans a QR code located at the building's entryway. This action prompts the frontend application on the guest's device to open a web application associated with the specific door ID embedded in the QR code. The frontend then transmits the device's geolocation and the door ID to the system's backend. In response, the backend validates that the guest's mobile device is in sufficient proximity to the entryway to prevent remote access attempts. Upon successful validation, the backend generates and returns a temporary guest JSON Web Token (JWT) to the frontend. The frontend stores this JWT, thereby authenticating the guest's session for subsequent actions, such as selecting a unit to contact.

FIG. 5B illustrates a representative flow for a guest requesting access from a tenant via a video or voice call, 205. Following authentication, the guest selects a specific unit number from a list displayed on the frontend and initiates a video or voice call request. The frontend transmits this call request, including the unit information, to the backend. The backend then initiates two parallel actions: first, it instructs a WebRTC (Web Real-Time Communication) server to establish a communication session, and second, it utilizes a service such as Twilio to send an SMS notification to the tenant associated with the selected unit. The tenant receives the notification and, by interacting with a provided link, joins the call, connecting them to the WebRTC session. The system then facilitates direct video and/or audio communication between the guest and the tenant. After the communication, the tenant makes a grant or deny decision, which is transmitted from their device through the frontend to the backend. If access is granted, the backend sends an "Access granted confirmation" back to the guest's frontend, which displays a "Door unlocked" message. Simultaneously, the backend publishes a door open command via the MQTT protocol to the physical Bellman entry control unit, which triggers the appropriate relay and opens the door. If access is denied, the backend sends an "Access denied" message to the guest's frontend, which displays a corresponding "Access denied" message, and the door remains locked.

FIG. 5C illustrates an alternative flow for a guest requesting access via an SMS-only interaction, 210. After authentication, the guest selects a unit and initiates an SMS-only access request via the frontend. The frontend forwards this request to the backend, which then instructs an SMS service, such as Twilio, to send a formatted request message to the tenant's mobile device, prompting a specific reply (e.g., "YES") to grant access. The tenant replies to the SMS. If the response is an affirmative command like "YES", the SMS service forwards the reply to the backend, typically via a webhook. The backend parses the response to confirm the positive command and then publishes a door open command via MQTT to the Bellman unit, which in turn triggers the relay to open the door. The backend may also send a confirmation SMS back to the tenant. If the tenant's response is negative or if a predefined time limit expires without a response, the backend registers the access as denied and sends a notification to the guest's frontend, which displays a message such as "Access not granted", and the door remains locked.

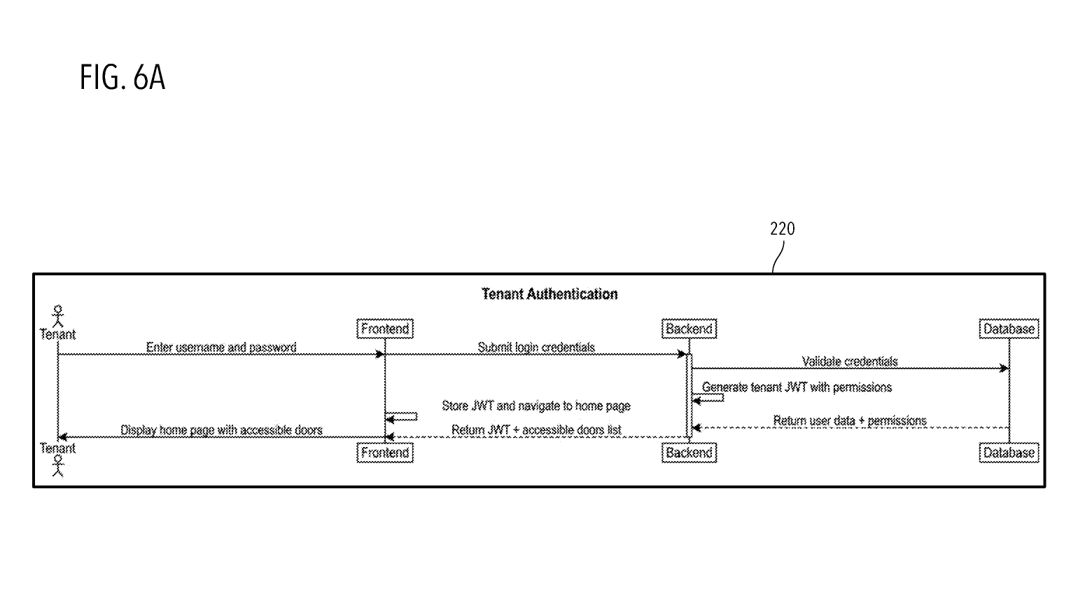

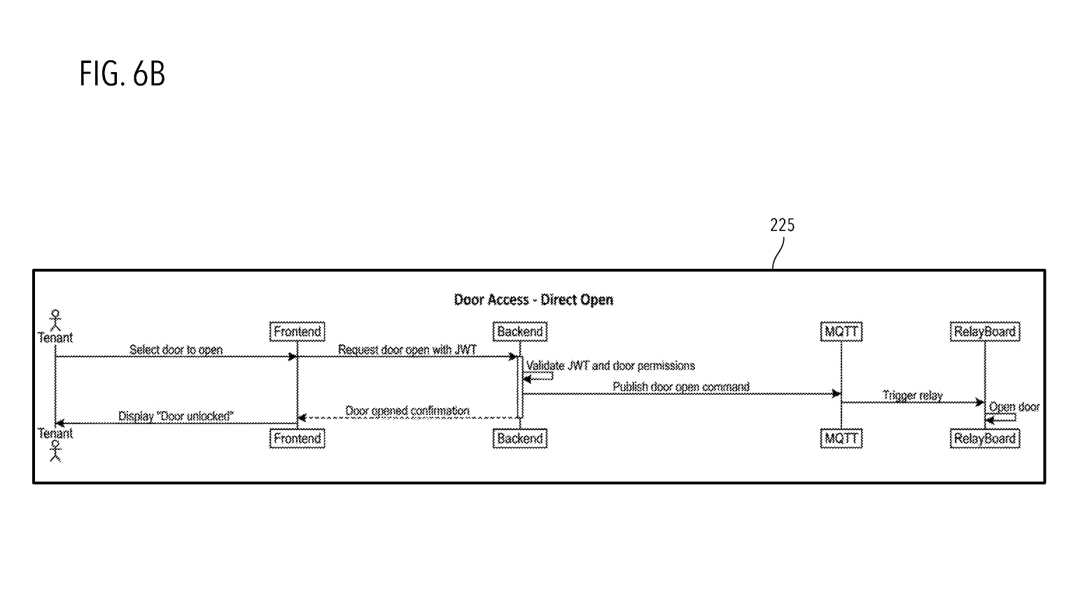

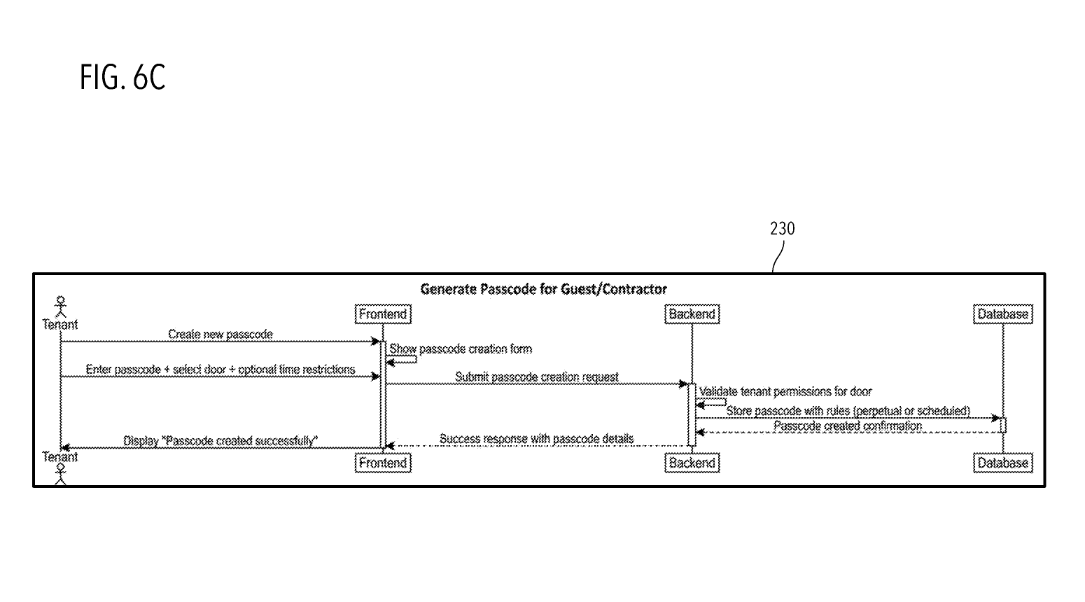

FIG. 6A illustrates a representative flow for tenant authentication, 215. The process begins when a tenant enters their username and password into a frontend application on their device. The frontend submits these login credentials to the system's backend for verification. The backend, in turn, queries a database to validate the credentials. Upon successful validation, the database returns the tenant's user data and associated permissions to the backend. The backend then generates a secure tenant JSON Web Token (JWT) that encapsulates these permissions. This JWT, along with a list of doors the tenant is authorized to access, is returned to the frontend. The frontend securely stores the JWT for the session, navigates to the main user interface, and displays a home page to the tenant that includes the list of accessible doors.

FIG. 6B illustrates a representative flow for direct door access by an authenticated tenant, 220. From the application's home page, the tenant selects a specific door to open. The frontend sends a door open request to the backend, including the tenant's stored JWT for authorization. The backend receives the request, validates the JWT, and confirms that the tenant's permissions allow access to the selected door. Upon successful validation, the backend publishes a door open command to a designated MQTT (Message Queuing Telemetry Transport) topic. This command is received by the physical entry control unit's relay board, which triggers the appropriate relay to de-energize and open the door lock. Concurrently, the backend sends a door opened confirmation message back to the frontend, which then displays a "Door unlocked" message to the tenant, providing real-time feedback.

FIG. 6C illustrates a representative flow for a tenant generating a temporary or permanent passcode for a guest or contractor, 225. The tenant initiates the process by selecting an option to "Create new passcode" within the frontend application. The frontend displays a passcode creation form, where the tenant can input a passcode, select the specific door it will operate, and define optional time-based restrictions, such as making it perpetual or scheduling it for specific days and times. Once submitted, the frontend sends a passcode creation request to the backend. The backend validates that the tenant has the necessary permissions to create a passcode for the selected door. Upon validation, the backend stores the new passcode and its associated rules in the system's database. After the database confirms the entry has been successfully stored, the backend sends a success response with the new passcode details back to the frontend, which then displays a "Passcode created successfully" confirmation message to the tenant.

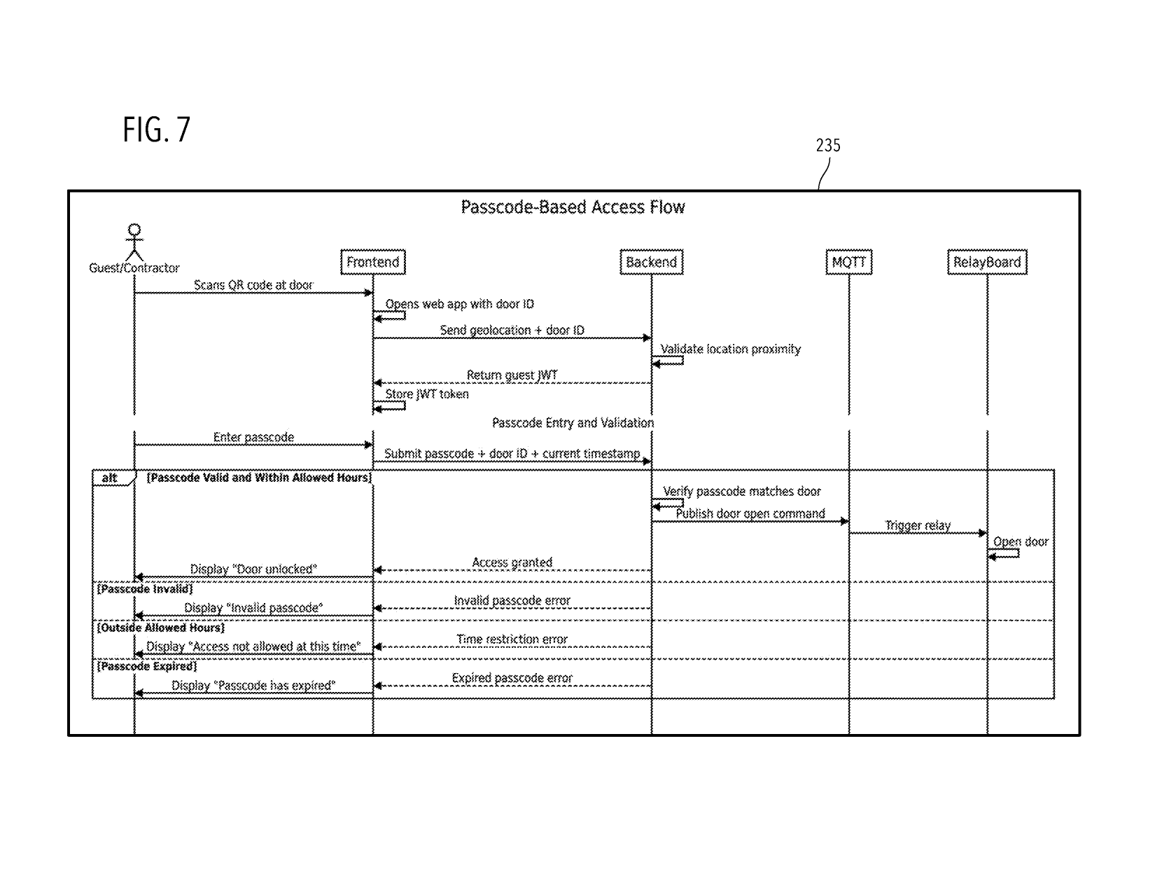

FIG. 7 illustrates a representative flow for a guest or contractor gaining access to a building entryway using a pre-issued passcode, 230. The process initiates when the user scans a QR code at the door with their mobile device, which causes the frontend application to open and transmit the device's geolocation and the door's ID to the system's backend. The backend validates the location proximity and, upon success, returns a temporary guest JSON Web Token (JWT) to the frontend to authenticate the session.

Following this initial authentication, the user enters their assigned passcode into the frontend. The frontend submits the passcode, the door ID, and the current timestamp to the backend for validation. The backend then evaluates the submission against several conditions. If the passcode is determined to be valid for the specified door and the current timestamp is within the allowed access hours, the backend proceeds with granting access. It publishes a door open command via the MQTT protocol to the physical relay board, which triggers the appropriate relay and opens the door. Concurrently, the backend sends an "Access granted" confirmation to the frontend, which displays a "Door unlocked" message to the user.

Alternatively, if the backend determines the passcode is incorrect, it returns an "Invalid passcode error" to the frontend, which displays an "Invalid passcode" message. If the passcode is correct but the access attempt is outside the scheduled hours, the backend returns a "Time restriction error," and the frontend displays "Access not allowed at this time." Finally, if the passcode is recognized but has expired, the backend returns an "Expired passcode error," prompting the frontend to display a "Passcode has expired" message. In all failure cases, access is denied, and the door remains locked.

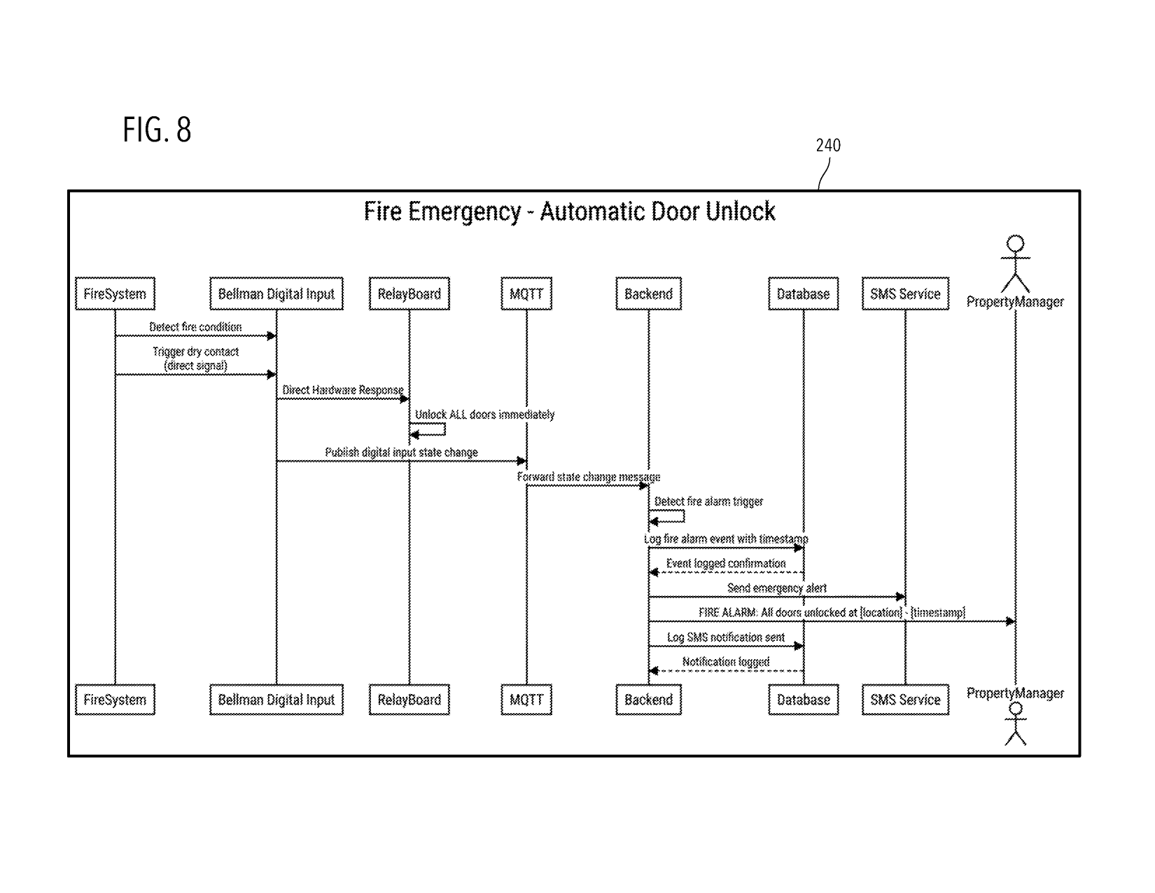

FIG. 8 illustrates a representative flow for the system's fire emergency protocol, 235, which facilitates an automatic and immediate unlocking of all connected doors for fail-safe operation. The process is initiated when the building's FireSystem detects a fire condition. Upon detection, the FireSystem triggers a dry contact, sending a direct electrical signal to the Bellman Digital Input component of the entry control unit.

This trigger initiates two parallel processes to ensure both immediate physical safety and timely notification. The first process is a direct hardware response that operates independently of the system's backend or network connectivity. The direct signal from the FireSystem to the Bellman Digital Input immediately commands the RelayBoard to de-energize all connected circuits. This action causes all associated electronic door strikes to unlock simultaneously, ensuring a fail-safe egress path for occupants and unimpeded ingress for first responders.

Concurrently with the hardware response, the state change at the Bellman Digital Input is published as a digital input state change message, typically via the MQTT protocol. This message is forwarded to the system's Backend, which detects the fire alarm trigger. The Backend then logs the fire alarm event with a precise timestamp in the Database and receives a confirmation that the event was successfully logged. Following this, the Backend instructs an SMS Service to send an emergency alert to a pre-configured PropertyManager or other designated personnel. The alert message may contain critical information such as the location and timestamp of the alarm. Finally, the SMS notification event is also logged in the Database for auditing and record-keeping purposes. This dual-path protocol ensures maximum safety and reliability by guaranteeing immediate door unlocking while simultaneously alerting relevant personnel and maintaining a complete record of the event.

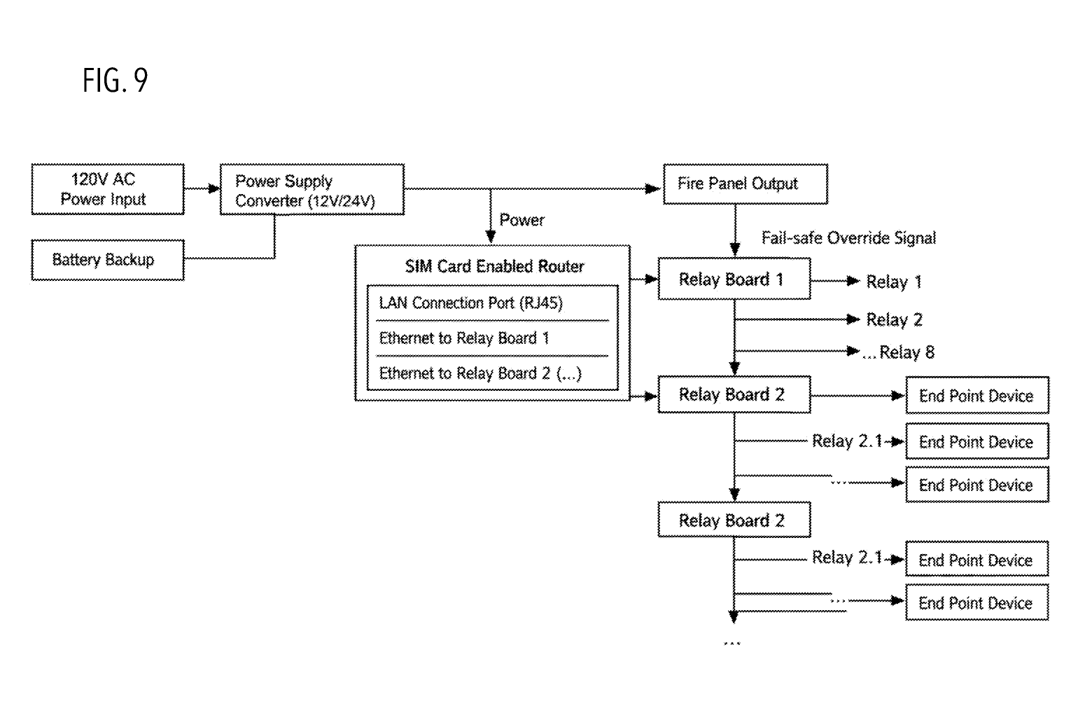

FIG. 9 illustrates a schematic block diagram of the electronic architecture of an exemplary entry control system, detailing the power distribution, data connectivity, and fail-safe override logic. The system is designed with redundant power sources, including a primary 120V AC Power Input and a Battery Backup. Both sources connect to a Power Supply Converter, which regulates the voltage (e.g., to 12V or 24V) to create a stable and continuous power bus for the system's components.

The central communication and processing hub is a SIM Card Enabled Router. This router receives power from the main power bus and is equipped with multiple output ports, including a general LAN connection port and dedicated Ethernet ports for communication with one or more Relay Boards. The router is responsible for receiving unlock commands from the backend server and transmitting them to the appropriate Relay Board.

Each Relay Board is an output control module that also receives power from the main power bus. It is configured to control a plurality of individual End Point Devices, such as electronic door strikes. As shown, Relay Board 1 can control relays 1 through 8, while subsequent Relay Boards can be added in a cascaded or parallel configuration to scale the system for controlling a larger number of doors. The diagram shows Relay Board 2 controlling End Point Devices via relays labeled 2.1 and so on, with the ellipsis indicating further expansion is possible.

Crucially, the architecture includes a direct hardware fail-safe mechanism that operates independently of the router and network communication. A Fire Panel Output is connected directly to each Relay Board in the system. In the event of a fire alarm, this connection delivers a Fail-safe Override Signal that commands all connected Relay Boards to immediately de-energize their respective relays, thereby ensuring all doors unlock for emergency access and egress.In an alternative embodiment, the functionality of telephone entry unit (TEU) 10 and electronic door strike 19 may be integrated into a single, self-contained apparatus. This integrated TEU door strike would be configured for installation directly into a door frame, replacing a conventional electronic door strike. Such a configuration would be particularly advantageous for single-entryway applications or scenarios where the installation of a separate housing unit is not practical, thereby simplifying the installation process by eliminating the need for wiring between a central control box and the entryway.

Structurally, the housing of this integrated TEU door strike would be adapted to enclose the core electronic components of the TEU system. Within this housing, a compact printed circuit board would comprise a communication module, such as an LTE modem 13, a microprocessor 22, and at least one relay 12. The integrated modem 13 would be configured to establish a direct wireless connection to the remote server 40. The onboard microprocessor 22 would be in communication with both the modem 13 and the relay 12. The relay 12, in turn, would be electrically connected to the strike's own solenoid 33. The entire apparatus would be powered by an external source, similar to a standard e-strike 19, and could further include a miniaturized internal battery backup 14 to ensure fail-safe operation during a power loss. This integrated door strike could also include a near field communication ("NFC") reader in communication with microprocessor 22 and at least one relay 12. In operation, the NFC reader of the integrated door strike would detect a user device's NFC output and upon that detection, would deenergize the door for entry. This event and action is simultaneously logged and sent to the remote server.

In operation, this integrated TEU door strike would function as a standalone, cloud-connected locking device. Following a visitor's scan of indicia 16 and a resident's remote approval, the remote server 40 would transmit a de-energize signal directly to the integrated modem 13 within the door strike. The onboard microprocessor 22 would authenticate this signal and actuate the internal relay 12, causing the solenoid 33 to de-energize and release the door latch L. This embodiment maintains the core security advantages of the system by keeping all processing and communication hardware concealed within the door frame M, away from public interaction, while offering a highly streamlined hardware footprint.

It should be appreciated that the various examples, although primarily directed to door entry systems, these examples could be readily used to control other systems that have a dry contact, e.g., gates, lighting, HVAC systems, etc.

It should be further noted that the various systems described herein can be standalone, or may run in parallel with existing entry systems, such as a standard key fob configured door entry system.

### EXAMPLES

The following provides a detailed description of certain exemplary embodiments of the present disclosure. It is to be understood that these embodiments are provided for illustrative purposes and are not to be construed as limiting the scope of the disclosure in any way.

In some aspects, the disclosure provides a telephone entry system having an entry unit, the entry unit comprising a power supply, a relay card in communication with the power supply, a router in communication with the relay card and the power supply, and a battery in communication with the power supply, at least one external entry sign having indicia thereon, and a remote server in communication with the router, wherein a camera for a first mobile device is arranged to capture an image of the indicia, thereby prompting the first mobile device to display a list and upon selecting a number from the list, the first mobile device sends an authorization communication to a second mobile device associated with the number in real-time, wherein the second mobile device is prompted to send a confirmation communication in response to receiving the authorization communication, thereby sending the confirmation communication to the remote server in real-time, wherein the remote server is prompted to send the confirmation communication to the router, thereby prompting the relay to transmit a signal to the at least one electric door strike to deenergize the door strike in real-time.

In some embodiments, the signal transmitted to the at least one electric door strike de-energizes the locking mechanism of the at least one electric door strike. The power supply may be in communication with an external power source. The relay card is in communication with a fire panel, the relay card adapted to transmit the signal to the at least one electric door strike to deenergize the door strike in response to the fire panel transmitting an emergency signal to the relay card. The indicia may be a QR code. The list displayed on the first mobile device may include unit numbers without displaying associated resident names for privacy. The authorization communication from the first mobile device to the second mobile device may be facilitated via the remote server without revealing a phone number of the second mobile device. The relay card may include a plurality of relay cards configured to control multiple electric door strikes. The entry unit may further include a housing enclosing the power supply, the relay card, the router, and the battery. The battery may be configured to provide backup power to the entry unit during a loss of the external power source. The telephone entry system may be configured to provide backup power to the entry unit during a loss of the external power source, and wherein the relay card may be configured to deenergize the at least one electric door strike to unlock the associated entryway upon receiving an emergency signal from a fire panel.

Further disclosed is an entry control apparatus for a building that includes a centralized entry unit including: the power supply connectable to the external power source, a battery backup in communication with the power supply, a relay bank having a microprocessor and a plurality of relays, the relay bank in communication with the power supply, a modem in communication with the relay bank and the power supply for connecting to the remote server, at least one indicia associated with an entryway, the indicia scannable by the first mobile device to initiate an access request via the remote server to the second mobile device; and wherein the remote server, upon receiving confirmation from the second mobile device, is configured to instruct the modem to activate at least one relay in the relay bank to deenergize an associated electric door strike.

In some embodiments, the relay bank is configured to receive emergency signals from a building fire panel. The plurality of relays may be between 1 and 32 relays. The indicia may be a QR code programmed to connect to a building-specific database on the remote server. The centralized entry unit may be configured to operate in a fail-safe mode during power loss using the battery backup.

In some aspects, the disclosure provides a cloud-based entry control network. The network may comprise a remote server, a centralized entry unit, and at least one indicia located at an entryway. The remote server can include an interactive database for storing user and building data, and a communication server for managing data flow. The centralized entry unit, in some embodiments, comprises a communication modem configured to establish a connection with the remote server, a microprocessor for processing commands, and a relay card. This relay card is electrically connected to at least one electronic door strike securing the entryway. In operation, the remote server is configured to receive an access request that is initiated when a first mobile device scans the indicia. The remote server can then transmit an authorization request to a second mobile device that is associated with the access request. Upon receiving an approval confirmation from the second mobile device, the remote server is configured to transmit an unlock command to the communication modem of the centralized entry unit. The microprocessor of the centralized entry unit is configured to interpret this unlock command and, in response, instruct the relay card to deenergize the at least one electronic door strike, thereby unlocking the entryway.

In another aspect of the disclosure, a telephone entry system is provided that incorporates geolocation verification for enhanced security. This system may comprise a centralized entry unit, a remote server, and at least one scannable indicia positioned at a known geographic location of an entryway. The centralized entry unit can include a communication modem, a microprocessor, and a relay card electrically connected to an electronic door strike. A first mobile device is configured to scan the scannable indicia, which generates an access request comprising both identification data from the indicia and geolocation data from the first mobile device itself. The remote server is configured to receive this access request and to validate the received geolocation data against the known geographic location associated with the entryway. Furthermore, in any of the foregoing embodiments, this validation step ensures the user is physically present at the entryway. Subsequent to a successful validation, the remote server may transmit an authorization request to a second mobile device. Upon receiving an approval from the second mobile device, the remote server is configured to transmit an unlock command to the centralized entry unit, which in turn causes the microprocessor to instruct the relay card to deenergize the electronic door strike. This geolocation feature may be incorporated into any of the network embodiments described herein to provide an additional layer of security against remote access attempts.

In an alternative embodiment, the functionalities of the centralized entry unit and the electronic door strike may be combined into a single, self-contained apparatus. This integrated TEU door strike can be configured for installation directly into a door frame, replacing a conventional electronic door strike and simplifying the installation by removing the need for separate wiring. The housing of such an integrated apparatus may be adapted to enclose the core electronic components, which can include a communication module, such as an LTE modem, a microprocessor, and at least one relay, all situated on a compact circuit board. A miniaturized internal battery backup may also be included to ensure operation during a power loss. In this configuration, the integrated communication module is adapted to establish a direct wireless connection to the remote server. The onboard microprocessor is configured to communicate with the modem and to control the internal relay, which in turn is electrically connected to the strike's own solenoid. Upon receiving an unlock command from the remote server, the microprocessor is configured to actuate the relay, thereby de-energizing the solenoid and releasing the door latch. This integrated embodiment can be utilized in any of the foregoing systems, maintaining the core security advantages by concealing all processing and communication hardware within the door frame.

It will be appreciated that various aspects of the disclosure and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

### CITATIONS

The following list of citations is hereby incorporated by reference herein in their entireties and such disclosures of related technologies may be incorporated into the system of the present invention:
U.S. Patent No. 10,854,027, issued Dec. 1, 2020;
U.S. Patent No. 10,521,992, issued Dec. 31, 2019;
U.S. Patent No. 10,305,966, issued May 28, 2019;
U.S. Patent No. 10,275,968, issued April 30, 2019;
U.S. Patent No. 9,990,787, issued June 5, 2018;
U.S. Patent App. Publication No. 2024/0054309, filed Oct. 5, 2020;
U.S. Patent App. Publication No. 2023/0047608, filed Dec. 1, 2020;
U.S. Patent App. Publication No. 2021/0335069, filed Jan. 27, 2021;
U.S. Patent App. Publication No. 2021/0258721, filed Feb. 3, 2021.

### REFERENCE NUMERALS

10 Telephone Entry Unit (TEU)

11 Power Supply

12 Relay Card

13 Router / Modem

14 Battery / Battery Backup

15 External Entry Sign

16 Indicia

17 Housing / Box

19 Electric Door Strike / Electronic Strike Plate

20 Camera

21 Fire Panel / Building Fire Panel

22 Microprocessor

23 External Power Source

24 Internal Antennae

25 Wire Power Connector

26 Battery Bank

27 Relay Bank

29 Air Vent

30 First Mobile Device

32 Second Mobile Device

33 Solenoid

34 Access Control System

35 Locking Mechanism

36 Indicator Light

37 QR-code

39 Camera image

40 Remote Server / Cloud Service

41 List

42 Interactive Database

100-150 Method steps

200, 205, 210… Processes

B Building

D Door

E Entryway

F Fan

L Latch

M Door frame

What is claimed is:

1. A telephone entry system, comprising:
an entry unit having:
a power supply;
a relay card in communication with the power supply;
a router in communication with the relay card and the power supply;
a battery in communication with the power supply;
at least one external entry sign having indicia thereon; and,
a remote server in communication with the router;
wherein a camera for a first mobile device is arranged to capture an image of the indicia, thereby prompting the first mobile device to display a list, and upon selecting or entering a number or other identifier from the list, the first mobile device sends an authorization communication to a second mobile device associated with the number in real-time;
wherein the second mobile device is configured to be prompted to send a confirmation communication in response to receiving the authorization communication, thereby sending the confirmation communication to the remote server in real-time; and,
wherein the remote server is configured to be prompted to send the confirmation communication to the router, adapted thereby to prompt the relay card to transmit a signal to the at least one electric door strike to deenergize the at least one door strike substantially in real-time.

2. The telephone entry system recited in claim 1, wherein the power supply is in communication with an external power source.

3. The telephone entry system recited in claim 1, wherein the relay card is in communication with a fire panel, the relay card adapted to transmit the signal to the at least one electric door strike to deenergize the door strike in response to the fire panel transmitting an emergency signal to the relay card.

4. The telephone entry system recited in claim 1, wherein the indicia comprises a QR code.

5. The telephone entry system recited in claim 1, wherein the list displayed on the first mobile device comprises unit numbers without displaying associated resident names for privacy.

6. The telephone entry system recited in claim 1, wherein the authorization communication from the first mobile device to the second mobile device is configured to be facilitated via the remote server without revealing a phone number of the second mobile device.

7. The telephone entry system recited in claim 1, wherein the relay card comprises a plurality of relay cards configured to control multiple electric door strikes.

8. The telephone entry system recited in claim 1, wherein the entry unit further comprises a housing enclosing the power supply, the relay card, the router, and the battery.

9. The telephone entry system recited in claim 1, wherein the battery is configured to provide backup power to the entry unit during a loss of the external power source.

10. The telephone entry system recited in claim 1, wherein the battery is configured to provide backup power to the entry unit during a loss of the external power source, and wherein the relay card is configured to deenergize the at least one electric door strike to unlock the associated entryway upon receiving an emergency signal from a fire panel.

11. A method for controlling access to a building entryway using a cloud-based telephone entry system, the method comprising:
providing an entry unit comprising a power supply, a relay card in communication with the power supply, a router in communication with the relay card and the power supply, and a battery in communication with the power supply;
providing at least one external entry sign having indicia thereon;
establishing communication between a remote server and the router;
capturing, by a camera of a first mobile device, an image of the indicia to prompt display of a list on the first mobile device;
selecting, via the first mobile device, a number from the list to send an authorization communication to a second mobile device associated with the number in real-time;
sending, via the second mobile device, a confirmation communication in response to receiving the authorization communication, the confirmation communication being sent to the remote server substantially in real-time; and,
sending, via the remote server, the confirmation communication to the router to prompt the relay card to transmit a signal to at least one electric door strike to deenergize the door strike.

12. The method recited in claim 11, further comprising powering the entry unit via an external power source in communication with the power supply.

13. The method recited in claim 11, further comprising receiving, by the relay card, an emergency signal from a fire panel and transmitting the signal to deenergize the at least one electric door strike in response thereto.

14. The method recited in claim 11, wherein displaying the list on the first mobile device includes unit numbers without associated resident names.

15. The method recited in claim 11, wherein sending the authorization communication occurs without revealing a phone number of the second mobile device.

16. An entry control apparatus for a building, comprising:
a centralized entry unit including:
a power supply connectable to an external power source;
a battery backup in communication with the power supply;
a relay bank having a microprocessor and a plurality of relay cards, the relay bank in communication with the power supply;
a modem in communication with the relay bank and the power supply for connecting to a remote server;
at least one indicia associated with an entryway, the indicia scannable by a first mobile device to initiate an access request via the remote server to a second mobile device; and,
wherein the remote server, upon receiving confirmation from the second mobile device, is configured to instruct the modem to activate at least one relay card in the relay bank to deenergize at least one electric door strike.

17. The entry control apparatus recited in claim 16, wherein the relay bank is configured to receive emergency signals from a building fire panel.

18. The entry control apparatus recited in claim 16, wherein the plurality of relay cards is between 1 and 32 relay cards.

19. The entry control apparatus recited in claim 16, wherein the indicia is a QR code programmed to connect to a building-specific database on the remote server.

20. The entry control apparatus recited in claim 16, wherein the centralized entry unit is configured to operate in a fail-safe mode during power loss using the battery backup.
